(19) United States
(12) Patent Application Publication
(10) Pub. No.: US 2026/0166664 A1
(43) Pub. Date: Jun. 18, 2026

(54) ENGINE HOSE ALIGNMENT DEVICE FOR AUTOMATION OF ENGINE HOSE ASSEMBLY

(71) Applicants: HYUNDAI MOTOR COMPANY, Seoul (KR); Kia Corporation, Seoul (KR)

(72) Inventors: Jihoon Yu, Gyeonggi-do (KR); Jung Wha Yeum, Gyeonggi-do (KR)

(21) Appl. No.: 19/183,440

(22) Filed: Apr. 18, 2025

(30) Foreign Application Priority Data
Dec. 18, 2024 (KR) 10-2024-0190558

(51) Int. Cl. B23P 19/04; B08B 9/032; B25J 11/00

(52) U.S. Cl. CPC B23P 19/042; B08B 9/0321; B25J 11/005

(57) ABSTRACT

An engine hose alignment device is used for automation of engine hose assembly. The engine hose alignment device includes a base plate configured to seat an engine hose thereon, where the engine hose is loaded adjacent to one side of the base plate in a temporary arrangement state and is transported by a robot arm, a position controller disposed around the engine hose seated on the base plate and configured to rotatably align the engine hose in the correct position set according to an assembly path of the robot arm, and a washing unit configured to deliver high-pressure air toward one end of the engine hose aligned in the correct position to thereby remove foreign substances from an inner side of the engine hose.

### CROSS-REFERENCE TO RELATED APPLICATION(S)

This application is based on and claims the benefit of 35 U.S.C. 119 to Korean Patent Application No. 10-2024-0190558, filed on Dec. 18, 2024, in the Korean Intellectual Property Office, the disclosure of which is herein incorporated by reference in its entirety.

### TECHNICAL FIELD

The present disclosure relates to an engine hose alignment device for automation of engine hose assembly, and more particularly, to an engine hose alignment device for automation of engine hose assembly, configured to align an engine hose in the correct position so as to implement automation of engine hose assembly using a robot arm.

### BACKGROUND

A vehicle engine serves as a core device of vehicle driving and is configured to generate power using explosive power of fuel injected into the vehicle engine along with air and to enable a vehicle to travel through the generated power. The vehicle engine may include a cylinder block, a cylinder head, a crankshaft, a camshaft, a cooling system, and a lubrication system.

For instance, the cylinder block combusts fuel through upward-and-downward movement of a piston. The cylinder head includes a valve and a combustion chamber and is configured to mix air and fuel and to manage exhaust gas. The crankshaft converts linear motion of the piston into rotary motion so as to generate motive power of the vehicle. The camshaft controls the opening and closing of the valve so as to improve efficiency in the combustion process. The cooling system dissipates heat generated from an engine so as to prevent overheating of the engine. The lubrication system serves to extend the life of components by reducing friction between the components.

The respective engine components are precisely and airtightly connected to each other by various engine hoses such as a coolant hose, an air intake hose, a fuel supply hose, and an oil line hose, thereby enabling stable operation of the respective engine components.

In some cases, a vehicle engine may be manufactured in a semi-automatic manner. For example, components supplied to an assembly line through a conveyor belt are moved to a designated location by a robot or a worker. Thereafter, various components and engine hoses are sequentially assembled directly using tools stored safely and organized on workbenches in a step-by-step work process.

In some cases, a semi-automatic engine manufacturing method may improve engine manufacturing productivity in association. However, the semi-automatic engine manufacturing method may depend on the skill level of a worker and an assembly environment. Further, in the semi-automatic engine manufacturing method, due to a large number of components, the assembly positions of the components may need to be accurately adjusted, assembly strengths of the components may not be consistent, and engine hoses having complex angles and directions may not be correctly assembled.

Particularly, since engine hoses assembled with an engine are amorphous parts having different curvatures, curved angles and directions, and thicknesses, accurate position adjustment and accurate clip coupling may be provided during assembly of the engine hoses, and hose specifications may be frequently modified due to a change in engine design or an improvement in engine hoses. As a result, it may be difficult to completely establish the engine hose assembly process with an automated system.

### SUMMARY

The present disclosure describes an engine hose alignment device for automation of engine hose assembly, configured not only to automate, through a robot arm or the like, an assembly process of an engine hose having a complex structure, but also to improve assembly efficiency and assembly quality of the engine hose by reliably removing foreign substances from the inside of the engine hose.

According to one aspect of the subject matter described in this application, an engine hose alignment device for automating engine hose assembly using a robot arm includes a base plate configured to seat an engine hose transported by the robot arm, a position controller arranged at the base plate and configured to rotatably align the engine hose to a preset position defined by an assembly path of the robot arm, and a washing unit disposed at the base plate and configured to deliver high-pressure air toward one end of the engine hose aligned at the preset position to thereby remove foreign substances from an inner side of the engine hose.

Implementations according to this aspect can include one or more of the following features. For example, the position controller can include a length controller disposed at the base plate and configured to linearly move the engine hose to thereby align a longitudinal axis of the engine hose in a preset orientation, and a direction controller disposed at the base plate and configured to rotate the engine hose in a first direction or a second direction opposite to the first direction to thereby orient an open end of the engine hose to a preset direction. For example,

In some implementations, the engine hose alignment device can include a plurality of guide plates that protrude from one side of the base plate and are arranged to guide the engine hose into the preset position based on operation of the length controller and the direction controller. In some implementations, the engine hose alignment device can include a plurality of position detection sensors that are disposed at the base plate around the position controller and that is configured to detect whether the engine hose is aligned with the preset position.

In some implementations, the washing unit can include an air compressor configured to generate the high-pressure air, a pneumatic pipe that is connected to the air compressor and extends toward a first end of the engine hose aligned with the preset position, and an exhaust pipe positioned at a second end of the engine hose and configured to discharge the high-pressure air having passed through the pneumatic pipe and the engine hose. In some examples, the washing unit further can include a flow rate sensor configured to measure a flow rate of the high-pressure air discharged through the exhaust pipe to thereby provide information about whether the engine hose is aligned with the preset position and has any defects in the inner side of the engine hose.

In some implementations, the direction controller can include a pair of rollers that are disposed at the base plate and extend parallel to the longitudinal axis of the engine hose, the pair of rollers having upper surfaces configured to support the engine hose, and a pair of rotary driving devices coupled to the pair of rollers, respectively, each of the pair of rotary driving devices being configured to rotate a corresponding one of the pair of rollers in the first or second direction. In some examples, each of the pair of rotary driving devices can include a rotary motor, where the direction controller further can include a pair of belts that connect the rotary motors to the pair of rollers, respectively, and that are configured to rotate the pair of rollers.

In some implementations, the length controller can include a movement plate disposed at the base plate and configured to move relative to the base plate in a horizontal direction along the longitudinal axis of the engine hose, and a linear driving device configured to linearly move the movement plate relative to the base plate. For instance, the linear driving device can include a linear motor.

According to another aspect, an engine hose alignment device for automating engine hose assembly using a robot arm includes a base plate configured to seat an engine hose transported by the robot arm, a plurality of motors arranged at the base plate and configured to move the engine hose to a preset position defined by an assembly path of the robot arm, and an air compressor configured to generate high-pressure air toward one end of the engine hose aligned at the preset position to thereby remove foreign substances from an inner side of the engine hose.

Implementations according to this aspect can include one or more of the following features. For example, the engine hose alignment device can include a position detection sensor disposed at the base plate and configured to detect whether the engine hose is aligned with the preset position. In some examples, the plurality of motors can include a linear motor and a rotary motor.

In some implementations, the engine hose alignment device can include a roller that is disposed at the base plate and extends parallel to a longitudinal axis of the engine hose, the roller having an upper surface configured to support the engine hose, where one of the plurality of motors is a rotary motor configured to rotate the roller. In some examples, the engine hose alignment device can include a belt that connects the rotary motor to the roller and is configured to rotate the roller.

In some implementations, the engine hose alignment device can include a movement plate disposed at the base plate and configured to move relative to the base plate in a horizontal direction along a longitudinal axis of the engine hose, where one of the plurality of motors is a linear motor configured to move the movement plate relative to the base plate in the horizontal direction.

In some implementations, the engine hose alignment device can include a plurality of guide plates that protrude from one side of the base plate and are arranged to guide the engine hose into the preset position based on operation of the plurality of motors. In some implementations, the engine hose alignment device can include a pneumatic pipe that is connected to the air compressor and extends toward a first end of the engine hose aligned with the preset position, and an exhaust pipe positioned at a second end of the engine hose and configured to discharge the high-pressure air having passed through the pneumatic pipe and the engine hose.

In some implementations, the engine hose alignment device can include a flow rate sensor configured to measure a flow rate of the high-pressure air discharged through the exhaust pipe to thereby provide information about whether the engine hose is aligned with the preset position and has any defects in the inner side of the engine hose.

### BRIEF DESCRIPTION OF THE DRAWINGS

The above and other objects, features, and other advantages of the present disclosure will be more clearly understood from the following detailed description taken in conjunction with the accompanying drawings.

FIG. 1 is a perspective view showing an example of an engine hose alignment device for automation of engine hose assembly.

FIG. 2 is a view showing an example of an operating state in which an engine hose is loaded on the engine hose alignment device shown in FIG. 1.

FIG. 3 is a view showing an example of an operating state in which a position controller shown in FIG. 1 aligns the engine hose in the longitudinal direction.

FIG. 4 is a view showing an example of an operating state in which the position controller shown in FIG. 1 aligns the open side of the engine hose.

FIG. 5 is a view showing an example of an operating state of a washing unit shown in FIG. 1.

### DETAILED DESCRIPTION

Hereinafter, reference will now be made in detail to the one or more implementations of the present disclosure, examples of which are illustrated in the accompanying drawings.

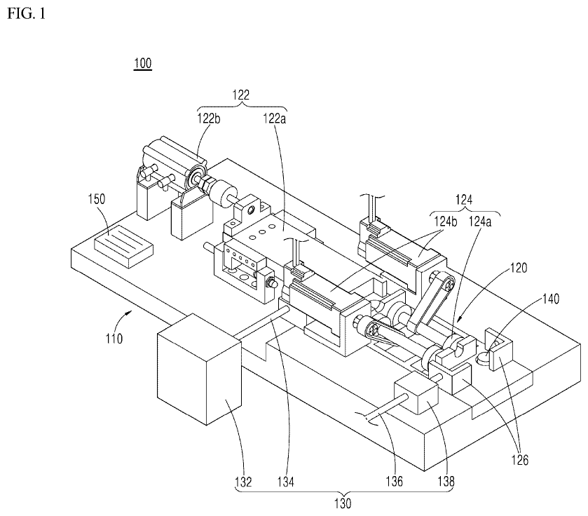

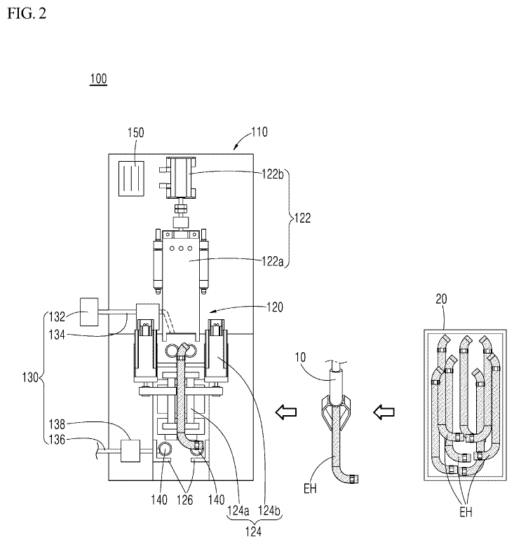

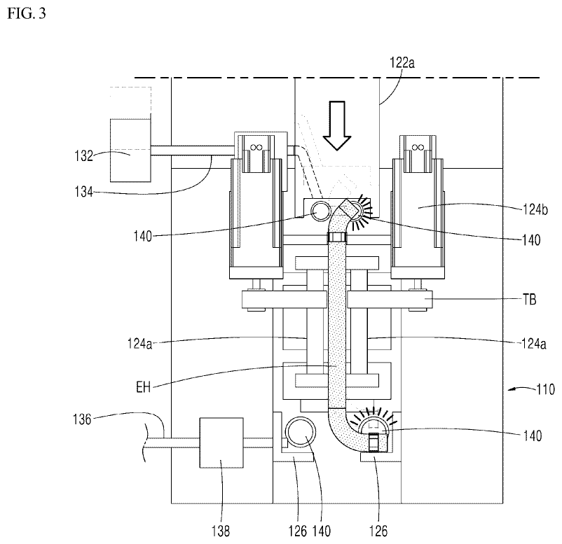

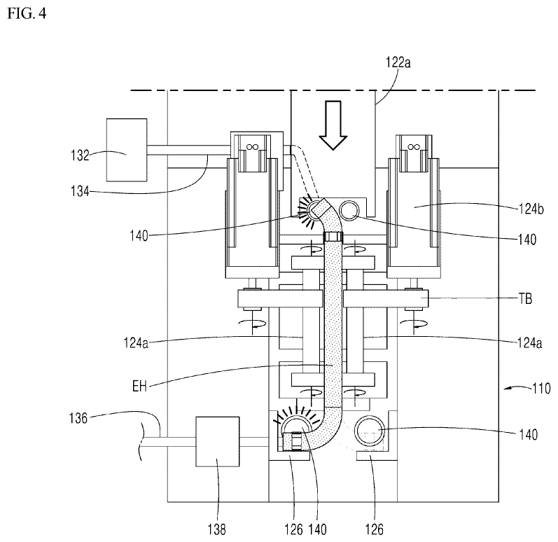

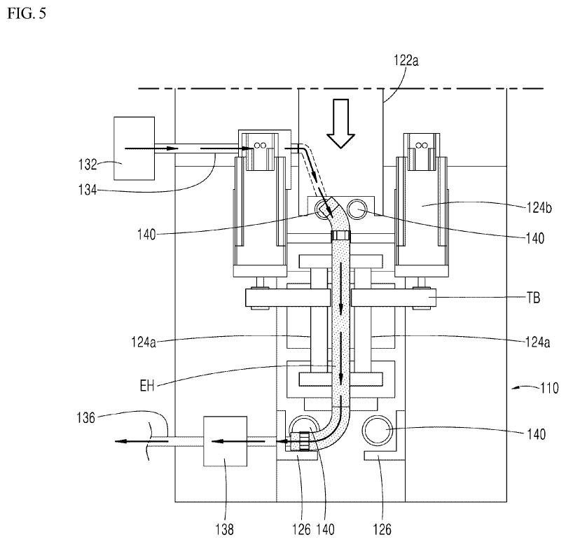

FIG. 1 is a perspective view showing an example of an engine hose alignment device for automation of engine hose assembly, FIG. 2 is a view showing an operating state in which an engine hose is loaded on the engine hose alignment device shown in FIG. 1, FIG. 3 is a view showing an operating state in which a position controller shown in FIG. 1 aligns the engine hose in the longitudinal direction, FIG. 4 is a view showing an operating state in which the position controller shown in FIG. 1 aligns the open side of the engine hose, and FIG. 5 is a view showing an operating state of a washing unit shown in FIG. 1.

In some implementations, an engine hose alignment device 100 for automation of engine hose assembly according to the present disclosure is a device configured to align an engine hose EH in the correct position for assembly automation of the engine hose EH using a robot arm 10. The engine hose alignment device 100 is configured to simplify a series of assembly processes of the robot arm 10, such as accurate gripping of the engine hose EH, movement of the engine hose EH to a mounting surface, insertion of the engine hose EH into the mounting surface, and coupling of a clip, to optimize an assembly path or a movement line of the robot arm 10, and to ensure that assembly by the robot arm 10 is accurately and quickly performed in a state in which foreign substances are removed from the inside of the engine hose EH.

In order to specifically implement the above-described function or operation, the engine hose alignment device 100 for automation of engine hose assembly can be configured to include a base plate 110, a position controller 120, a washing unit 130, and a position detection sensor 140, as shown in FIG. 1.

Hereinafter, the above-described components will be described in detail.

In some implementations, the base plate 110 is a component configured to provide a space allowing the engine hose EH to be mounted therein. Here, the engine hose EH is loaded adjacent on one side of the base plate 110 in a temporary arrangement state and is transported by the robot arm 10 or a worker. Further, the base plate 110 is a component configured to provide an installation surface allowing respective components to be described later to be mounted thereon.

The base plate 110 can be manufactured as a flat plate made of metal having high strength and high durability or synthetic resin.

As shown in FIG. 2, the base plate 110 can be installed adjacent to a loading box 20 configured for the engine hoses EH to be temporarily loaded and arranged therein. Here, the base plate 110 can be located within an operating range of the worker or the robot arm 10 provided in an engine assembly line moved through a conveyor belt.

In order to simplify a series of the assembly processes of the robot arm 10 for the engine hose EH and to optimize an assembly path or a movement line of the robot arm 10, the position controller 120 is configured to rotatably align the engine hose EH arbitrarily seated or loaded on the base plate 110 from the loading box 20 in a correct position set according to the assembly path or the movement line of the robot arm 10.

In some examples, the correct position of the engine hose EH is different from a seating position of the engine hose EH on the base plate 110. Specifically, the temporarily arranged engine hose EH is gripped by the robot arm 10 or the worker from the loading box 20 and then is temporarily loaded on the seating position of the base plate 110 in a state in which the longitudinal direction and the open side of the engine hose EH are not accurately aligned on the base plate 110. Here, the correct position refers to an initial position of the assembly path or the movement line of the robot arm 10 set for the operation of connecting the engine hose EH to an engine.

The correct position can be determined in consideration of the specifications of the engine hose EH (curvature, curved angle and direction, thickness, and the like) and the position of the mounting surface into which the engine hose EH is inserted when the assembly path of the robot arm 10 for the engine hose EH is designed.

In order to implement the above-described function and operation, the position controller 120 can be configured to include a length controller 122, a direction controller 124, and a guide plate 126 each installed around the engine hose EH mounted on the base plate 110, as shown in FIGS. 2 to 4.

Here, the length controller 122 is a component configured to linearly move the engine hose EH such that the engine hose EH is placed in the correct position in the longitudinal direction. Here, as described above, the engine hose EH is gripped by the robot arm 10 or the worker from the loading box 20 and then is loaded on any position on the base plate 110 having the position controller 120 installed thereon.

As shown in FIGS. 2 and 3, the length controller 122 can be configured to include a movement plate 122a and a linear driving device 122b each installed on the base plate 110.

The movement plate 122a is a component configured to be horizontally slidable in the longitudinal direction of the engine hose EH seated on the base plate 110 by the robot arm 10 or the worker, and to move the seated engine hose EH in the longitudinal direction. The movement plate 122a can be formed of a flat plate-shaped member.

In this case, the movement plate 122a can have a guide protrusion formed on an end portion thereof, the end portion contacting one side of the engine hose EH. The guide protrusion can be formed to correspond to the shape of one side of the engine hose EH so as to induce and guide longitudinal movement of the engine hose EH.

The linear driving device 122b is a component configured for the movement plate 122a to linearly reciprocate through the operation control of a main controller 150 configured to perform overall control of the engine hose alignment device. For example, the linear driving device 122b can include a linear motion device such as a linear motor.

In some examples, the linear driving device 122b can include a linear actuator including a motor, a screw shaft, and a moving block for fine and accurate linear movement.

Through the length controller 122, the engine hose EH loaded at any position of the base plate 110 can be aligned by continuous movement thereof until the other side of the engine hose EH is in close contact with the guide plate 126 to be described later in the longitudinal direction.

The direction controller 124 is a component configured to perform forward or reverse rotation of the engine hose EH such that an open side of the engine hose EH aligned in the longitudinal direction by the length controller 122 is placed in the correct position.

As shown in FIG. 4, the direction controller 124 can be configured to include a pair of rollers 124a and a pair of rotary driving devices 124b installed on the base plate 110.

The pair of rollers 124a is a component configured to change the direction of the engine hose EH so as to allow the open side of the engine hose EH aligned in the longitudinal direction to be inserted into the mounting surface along the assembly path or the movement line of the robot arm 10.

The rollers 124a can be formed of a pair of cylindrical members rotatably spaced apart from each other on the base plate 110 in a direction parallel to the longitudinal direction of the engine hose EH. In this manner, the engine hose EH is seated on the upper portions of the pair of rollers.

Each of the rotary driving devices 124b is a component configured to rotate a corresponding one of the rollers 124a in the forward or reverse direction through the operation control of the main controller 150 configured to perform the overall control of the engine hose alignment device. Here, if each of the rotary driving devices 124b is a known rotary device, the driving method thereof is not particularly limited.

In some implementations, the rotary driving device 124b can include a motor for precise rotation control and a belt TB configured to transmit rotational power of the motor to the roller 124a.

Through the direction controller 124, the open side of the engine hose EH aligned in the longitudinal direction after being loaded at any position of the base plate 110 can be moved to a correct position allowing the open side of the engine hose EH to be inserted into the mounting surface along the assembly path or the movement line of the robot arm 10.

In this case, movement of the engine hose EH to the correct position can be accurately guided by the guide plate 126 to be described later and the guide protrusion of the movement plate 122a.

The guide plate 126 is a plate-shaped component formed to protrude from one side of the base plate 110. Further, the guide plate 126 interacts with the length controller 122 and the direction controller 124 and guides the engine hose EH so as to place the same in the correct position.

As shown in FIGS. 1 and 2, a plurality of guide plates 126 can be provided on the base plate 110 in a symmetrical manner corresponding to the outer shape of the engine hose EH seated in the correct position and can be slidably moved so as to adjust the position thereof on the base plate 110 corresponding to the shapes of various engine hoses EH.

The position detection sensor 140 is a component installed on the base plate 110 around the position controller 120 and configured to detect whether the engine hose EH is in the correct position. The position detection sensor 140 can be configured to be electrically connected to the main controller 150 so as to transmit detected information to the main controller 150.

In order to detect the correct position of the engine hose EH, a pair of position detection sensors 140 can be installed to respectively contact the opposite ends of the engine hose EH placed in the correct position, as shown in FIG. 4.

In addition, the position detection sensors 140 can be installed to respectively contact the opposite ends of the engine hose EH placed in the opposite direction relative to the correct position, thereby detecting the engine hose EH that is not aligned in the correct position.

The operation method of each of the position detection sensors 140 is not particularly limited as long as each of the position detection sensors is a commercially available sensor device capable of detecting an object present in the detection direction in a contact or non-contact manner, such as a load cell or a distance measurement sensor.

Since a plurality of position detection sensors 140 is installed on the base plate 110, the position controller 120 can perform the operation of automatically aligning the engine hose EH in the correct position step by step according to the operation control of the main controller 150 based on detected information.

The washing unit 130 is a component configured to remove foreign substances from the inside of the engine hose EH so as to prevent initial operation trouble or failure of the engine. Further, the washing unit 130 can be electrically connected to the main controller 150 and can be controlled in a state of being installed on one side of the base plate 110.

The washing unit 130 can be configured to include an air compressor 132, a pneumatic pipe 134, and an exhaust pipe 136, as shown in FIGS. 1 and 5. Here, foreign substances can be removed from the engine hose EH by delivering high-pressure air toward one side of the engine hose EH aligned in the correct position.

The air compressor 132 is a component installed on the base plate 110 and configured to deliver high-pressure air. The air compressor 132 can be a commercially available compressor capable of being controlled by the main controller 150 based on correct position information detected by the position detection sensor 140.

The pneumatic pipe 134 is a component installed on the base plate 110 so as to face one side of the aligned engine hose EH in a state of being connected to the air compressor 132.

The pneumatic pipe 134 can be formed of a pipe body provided at one end thereof, the one end being connected to the air compressor 132, and a flow path provided at the other end thereof. Here, the other end of the pneumatic pipe 134 passes through the movement plate 122a so as to face one side of the aligned engine hose EH and communicates with the pipe body.

The exhaust pipe 136 is a component installed on the base plate 110 so as to face the other side of the aligned engine hose EH and configured to discharge high-pressure air delivered through the pneumatic pipe 134 and the engine hose EH to the outside.

One end of the exhaust pipe 136 can face the other end of the aligned engine hose EH, and the other end thereof can face the outside.

A flow rate sensor 138 is a component configured to determine whether the engine hose EH is in the correct position or whether there is a defect inside the engine hose EH. Further, the flow rate sensor 138 can be electrically connected to the main controller 150 and can transmit detected flow rate information to the main controller 150.

As shown in FIG. 5, the flow rate sensor 138 can be provided on one side of the exhaust pipe 136 so as to measure the amount of air discharged through the exhaust pipe 136.

The operation method of the flow rate sensor 138 is not particularly limited as long as the flow rate sensor 138 is a commercially available sensor device capable of measuring the flow of air.

Since the flow rate sensor 138 is installed on one side of the exhaust pipe 136, the main controller 150 can compare the amount of air delivered from the air compressor 132 with the measured air flow rate information, thereby making it possible not only to determine whether the engine hose EH is in the correct position, but also to determine whether the engine hose EH is deformed or defective or contains foreign substances therein in a real-time manner.

The main controller 150 can be a component configured to control the operation of each of the length controller 122, the direction controller 124, the washing unit 130, and the position detection sensor 140 in a state of being electrically connected thereto. Further, the main controller 150 is configured to receive, monitor, and process detected or measured information or data.

The main controller 150 is formed of information processing units capable of programming information calculation and sequence control, such as an electric circuit, a micro controller unit (MCU), a microcomputer, and an Arduino programmable logic controller (PLC), and precisely controls the respective components connected to each other as described above, thereby making it possible not only to quickly and accurately automate the assembly of the engine hose EH through the robot arm 10, but also to prevent or reduce initial operation trouble or failure of the engine by removing foreign substances from the inside of the engine hose EH.

As is apparent from the above description, an engine hose loaded adjacent to one side of a base plate in a temporary arrangement state is transported by a robot arm and is seated on the base plate, and a position controller configured to rotatably align the engine hose in a correct position set according to an assembly path or a movement line of the robot arm is installed around the engine hose seated on the base plate, thereby making it possible to simplify, without an unnecessary process, a series of assembly processes of the robot arm, such as accurate gripping of the engine hose for engine hose assembly, movement of the engine hose to the mounting surface, insertion of the engine hose into the mounting surface, and coupling of a clip, to easily optimize the assembly path or the movement line of the robot arm, to reduce defective assembly through accurate and rapid engine hose assembly, and to improve productivity by the robot arm.

Additionally, since a washing unit configured to deliver high-pressure air toward one side of the engine hose aligned in the correct position is installed on the base plate, foreign substances can be readily removed from the inside of the engine hose aligned in the correct position. In this manner, it is possible to prevent or reduce initial operation trouble or failure of the engine.

Although the present disclosure has been described in detail with reference to implementations thereof, the scope of the present disclosure is not limited to the above-described implementations and the accompanying drawings, and it will be appreciated by those skilled in the art that various modifications and improvements can be made in the implementations without departing from the principles and spirit of the disclosure, the scope of which is defined in the appended claims and equivalents thereto. Accordingly, such modifications and improvements should not be individually understood from the technical idea or viewpoint of the present disclosure, and the modifications fall within the scope of the claims of the present disclosure.

What is claimed is:

1. An engine hose alignment device for automating engine hose assembly using a robot arm, the engine hose alignment device comprising:
a base plate configured to seat an engine hose transported by the robot arm;
a position controller arranged at the base plate and configured to rotatably align the engine hose to a preset position defined by an assembly path of the robot arm; and
a washing unit disposed at the base plate and configured to deliver high-pressure air toward one end of the engine hose aligned at the preset position to thereby remove foreign substances from an inner side of the engine hose.

2. The engine hose alignment device of claim 1, wherein the position controller comprise:
a length controller disposed at the base plate and configured to linearly move the engine hose to thereby align a longitudinal axis of the engine hose in a preset orientation; and
a direction controller disposed at the base plate and configured to rotate the engine hose in a first direction or a second direction opposite to the first direction to thereby orient an open end of the engine hose to a preset direction.

3. The engine hose alignment device of claim 2, further comprising a plurality of guide plates that protrude from one side of the base plate and are arranged to guide the engine hose into the preset position based on operation of the length controller and the direction controller.

4. The engine hose alignment device of claim 1, further comprising a plurality of position detection sensors that are disposed at the base plate around the position controller and that is configured to detect whether the engine hose is aligned with the preset position.

5. The engine hose alignment device of claim 1, wherein the washing unit comprises:
an air compressor configured to generate the high-pressure air;
a pneumatic pipe that is connected to the air compressor and extends toward a first end of the engine hose aligned with the preset position; and
an exhaust pipe positioned at a second end of the engine hose and configured to discharge the high-pressure air having passed through the pneumatic pipe and the engine hose.

6. The engine hose alignment device of claim 5, wherein the washing unit further comprises a flow rate sensor configured to measure a flow rate of the high-pressure air discharged through the exhaust pipe to thereby provide information about whether the engine hose is aligned with the preset position and has any defects in the inner side of the engine hose.

7. The engine hose alignment device of claim 2, wherein the direction controller comprises:
a pair of rollers that are disposed at the base plate and extend parallel to the longitudinal axis of the engine hose, the pair of rollers having upper surfaces configured to support the engine hose; and
a pair of rotary driving devices coupled to the pair of rollers, respectively, each of the pair of rotary driving devices being configured to rotate a corresponding one of the pair of rollers in the first or second direction.

8. The engine hose alignment device of claim 7, wherein each of the pair of rotary driving devices comprises a rotary motor, and
wherein the direction controller further comprises a pair of belts that connect the rotary motors to the pair of rollers, respectively, and that are configured to rotate the pair of rollers.

9. The engine hose alignment device of claim 2, wherein the length controller comprises:
a movement plate disposed at the base plate and configured to move relative to the base plate in a horizontal direction along the longitudinal axis of the engine hose; and
a linear driving device configured to linearly move the movement plate relative to the base plate.

10. The engine hose alignment device of claim 9, wherein the linear driving device comprises a linear motor.

11. An engine hose alignment device for automating engine hose assembly using a robot arm, the engine hose alignment device comprising:
a base plate configured to seat an engine hose transported by the robot arm;
a plurality of motors arranged at the base plate and configured to move the engine hose to a preset position defined by an assembly path of the robot arm; and
an air compressor configured to generate high-pressure air toward one end of the engine hose aligned at the preset position to thereby remove foreign substances from an inner side of the engine hose.

12. The engine hose alignment device of claim 11, further comprising a position detection sensor disposed at the base plate and configured to detect whether the engine hose is aligned with the preset position.

13. The engine hose alignment device of claim 11, wherein the plurality of motors comprise a linear motor and a rotary motor.

14. The engine hose alignment device of claim 11, further comprising:
a roller that is disposed at the base plate and extends parallel to a longitudinal axis of the engine hose, the roller having an upper surface configured to support the engine hose,
wherein one of the plurality of motors is a rotary motor configured to rotate the roller.

15. The engine hose alignment device of claim 14, further comprising:
a belt that connects the rotary motor to the roller and is configured to rotate the roller.

16. The engine hose alignment device of claim 11, further comprising:
a movement plate disposed at the base plate and configured to move relative to the base plate in a horizontal direction along a longitudinal axis of the engine hose,
wherein one of the plurality of motors is a linear motor configured to move the movement plate relative to the base plate in the horizontal direction.

17. The engine hose alignment device of claim 11, further comprising a plurality of guide plates that protrude from one side of the base plate and are arranged to guide the engine hose into the preset position based on operation of the plurality of motors.

18. The engine hose alignment device of claim 11, further comprising:
a pneumatic pipe that is connected to the air compressor and extends toward a first end of the engine hose aligned with the preset position; and
an exhaust pipe positioned at a second end of the engine hose and configured to discharge the high-pressure air having passed through the pneumatic pipe and the engine hose.

19. The engine hose alignment device of claim 18, further comprising a flow rate sensor configured to measure a flow rate of the high-pressure air discharged through the exhaust pipe to thereby provide information about whether the engine hose is aligned with the preset position and has any defects in the inner side of the engine hose.
